(19) United States
(12) Patent Application Publication
(10) Pub. No.: US 2026/0169933 A1
(43) Pub. Date: Jun. 18, 2026

(54) REMOTE MEMORY TRAFFIC MANAGEMENT

(71) Applicant: Advanced Micro Devices, Inc., Santa Clara, CA (US)

(72) Inventors: Alexander J. Branover, Boxborough, MA (US); Xuanhua Li, Austin, TX (US); Narendra Kamat, Austin, TX (US); Eric Christopher Morton, Austin, TX (US); Ravindra N. Bhargava, Austin, TX (US)

(73) Assignee: Advanced Micro Devices, Inc., Santa Clara, CA (US)

(21) Appl. No.: 18/984,735

(22) Filed: Dec. 17, 2024

(51) Int. Cl. G06F 13/16

(52) U.S. Cl. CPC G06F 13/16; G06F 2213/16

(57) ABSTRACT

The disclosed device includes a data fabric controller that can identify which computing nodes are more biased to remote memory traffic and which computing nodes are more biased to local memory traffic. In response to detecting a load condition on a remote memory device, the data fabric controller can throttle one of the computing nodes that are biased to remote memory traffic. Various other methods, systems, and computer-readable media are also disclosed.

### BACKGROUND

A computing device can use a tiered memory system that can include local or host memory (e.g., local to the computing device such as attached locally to a computing node/circuit) and remote memory (e.g., remote from the computing device) such as fabric-attached memory (FAM) that can be attached through a switch or other network, device-attached memory that can be attached through a peripheral bus (e.g., as a memory expanding device) and/or other memory devices that may be located externally to a data pipeline between a processing circuit and the local memory of the computing device (e.g., a CPU accessing a shared memory on an accelerator device attached through a peripheral bus). A data fabric can correspond to a data pipeline architecture within a computing device for linking data sources (e.g., memory devices) with processing circuits (e.g., processors, peripherals, etc.) that access data from the data sources. Although the data fabric can include controllers for managing local memory traffic, the data fabric can be limited with respect to managing remote memory traffic.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an example system for remote memory traffic management.

FIG. 2 is a block diagram of a simplified architecture for remote memory traffic management.

FIG. 3 is a state diagram for remote memory traffic management.

FIG. 4 is a flow diagram of an example method for remote memory traffic management.

FIG. 5 is a flow diagram of another example method for remote memory traffic management.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to remote memory traffic management. As will be explained in greater detail below, implementations of the present disclosure identify, from processing circuits coupled to remote memory devices and local memory devices, which processing circuits have memory traffic that is more biased to the remote memory devices than to the local memory devices. In response to a load condition on at least one of the remote memory devices, implementations of the present disclosure can accordingly throttle memory traffic from the remote-memory-biased processing circuit. By throttling memory traffic from the remote-memory-biased processing circuit the systems and methods described herein provide a local control mechanism for addressing remote memory issues, thereby mitigating interference from remote memory devices on performance of local memory devices. Local memory traffic can correspond to more performance-sensitive traffic which can experience a performance decrease from memory traffic congestion on a data fabric due to stalls from remote memory traffic. Accordingly, the systems and methods provided herein advantageously improve the functioning of a computer itself by mitigating performance decrease of performance-sensitive memory traffic when a load condition on a remote memory device creates memory traffic congestion.

Features from any of the implementations described herein can be used in combination with one another in accordance with the general principles described herein. These and other implementations, features, and advantages will be more fully understood upon reading the following detailed description in conjunction with the accompanying drawings and claims.

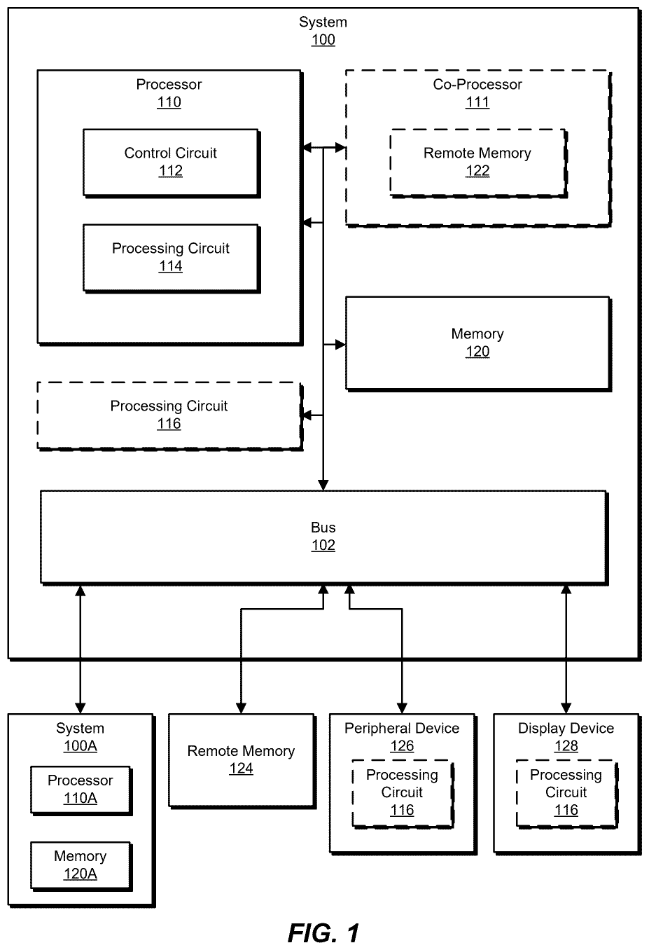

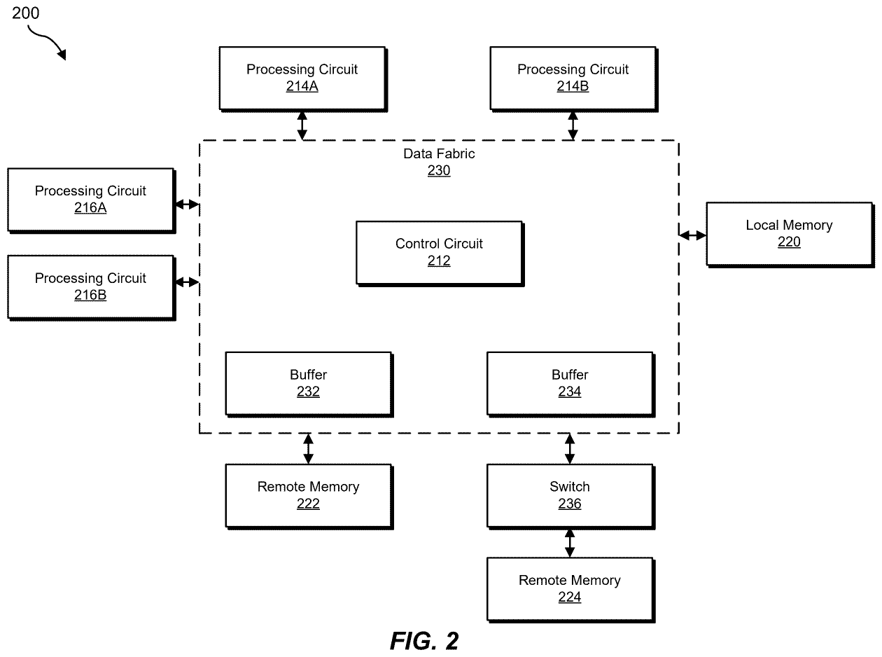

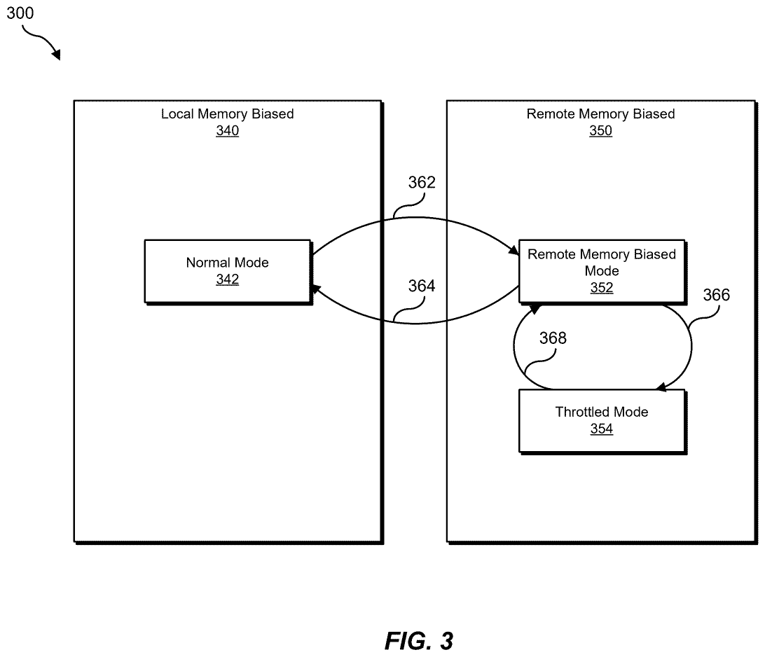

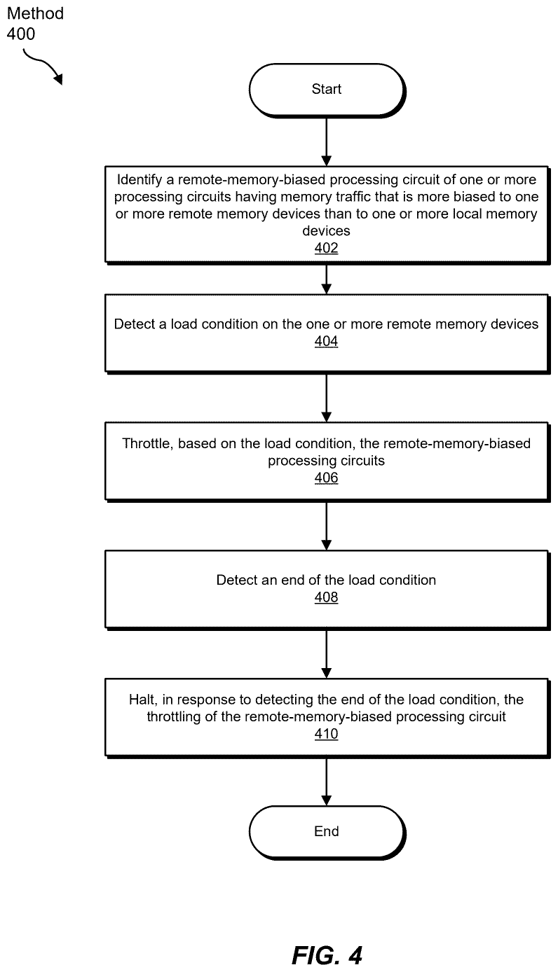

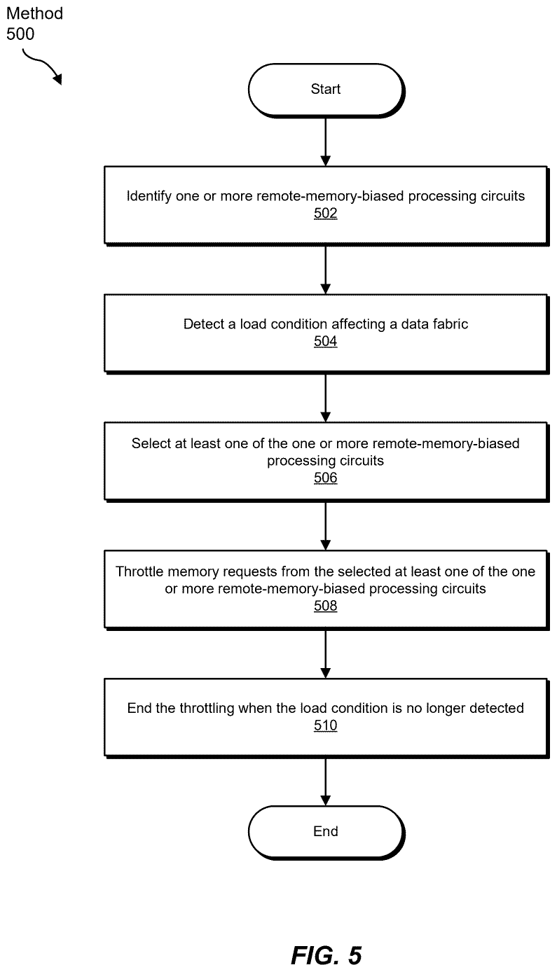

The following will provide, with reference to FIGS. 1-4, detailed descriptions of remote memory traffic management. Detailed descriptions of example system will be provided in connection with FIGS. 1 and 2. Detailed descriptions of transitioning between operational modes will be provided in connection with FIG. 3. Detailed descriptions of corresponding computer-implemented methods will also be provided in connection with FIGS. 4-5.

FIG. 1 is a block diagram of an example system 100 for remote memory traffic management. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory. In some examples, memory 120 can correspond to a local memory, including a fast memory such as dynamic random-access memory (DRAM).

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same (e.g., a host processor and a co-processor), and/or any other suitable physical processor(s). Further, in some examples, processor 110 can be a general-purpose processor that can be capable, without significant limitation, of various computing tasks, as opposed to a special purpose processor that can be limited in computing tasks (e.g., specially designed for particular computing tasks such as moving data, performing certain mathematical operations, etc.), although in other examples processor 110 can correspond to and/or incorporate one or more special purpose processors.

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), neural processing units (NPUs), tensor processing units (TPUs), other highly parallel processor units (PPUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100. Although not illustrated in FIG. 1, in some implementations, system 100 can be coupled to a display device (e.g., via bus 102).

As further illustrated in FIG. 1, processor 110 includes a control circuit 112, and a processing circuit 114. Control circuit 112 corresponds to a controller (e.g., of a data fabric) and includes circuitry and/or instructions for managing memory traffic, such as requests and responses between processor 110 and memory 120. Processing circuit 114 corresponds to any processing circuit that can access (e.g., read and/or write) data from a memory device, such as a processor core, input/output (I/O) device, etc. System 100 also includes a processing circuit 116 corresponding to another processing circuit (e.g., I/O device, accelerator device, peripheral device, display device, etc.).

In addition, FIG. 1 illustrates a remote memory 122 and a remote memory 124. Remote memory 122 corresponds to a memory device that can be shared (e.g., remotely accessible by processing circuit 114 and/or processing circuit 116). In some examples, co-processor 111 can correspond to an accelerator having a memory (e.g., remote memory 122) that can be shared. Remote memory 124 can correspond to a memory device that can be a network, including any links, interfaces, network devices, etc. therebetween. In some examples, remote memory 124 can correspond to a FAM. Moreover, in some implementations control circuit 112 can manage memory traffic between processing circuits (e.g., processor 110, processing circuit 114, and/or processing circuit 116) and local memory devices (e.g., memory 120) and remote memory devices (e.g., remote memory 122 and/or remote memory 124). Further, although FIG. 1 generally illustrates a single instance of components, in other examples, one or more of the components (e.g., processing circuit 114, processing circuit 116, remote memory 122, and/or remote memory 124) can correspond to or otherwise represent multiple separate instances and/or variations thereof.

FIG. 1 illustrates further examples of processing circuit 116 and remote memory. In some examples, system 100 can be coupled (e.g., via bus 102 or another appropriate interface) to a peripheral device 126 (corresponding to any peripheral device described herein) and/or a display device 128 (corresponding to any display device described herein). Peripheral device 126 and/or display device 128 can include respective iterations of processing circuit 116 that can access any connected remote memory (e.g., remote memory 122 and/or remote memory 124).

FIG. 1 further illustrates a system 100A (corresponding to a separate iteration of system 100) coupled to system 100 and that includes a processor 110A (corresponding to a separate iteration of processor 110) and a memory 120A (corresponding to a separate iteration of memory 120). In some examples, system 100A (e.g., processor 110A and/or any processing circuit thereof) can access the local memory of system 100 (e.g., memory 120) as a remote memory (e.g., memory that is remote to system 100A). Further, in some examples, system 100 (e.g., processor 110, processing circuit 114 and/or processing circuit 116) can access the local memory of system 100A (e.g., memory 120A) as a remote memory (e.g., memory that is remote to system 100 similar to remote memory 124).

FIG. 2 illustrates a system 200 (corresponding to system 100) of a data fabric-centric view of an example architecture for remote memory traffic management. FIG. 2 includes a local memory 220 (corresponding to memory 120), a processing circuit 214A (corresponding to an iteration of processing circuit 114), a processing circuit 214B (corresponding to another iteration of processing circuit 114), a processing circuit 216A (corresponding to processing circuit 116), a processing circuit 216B (corresponding to another iteration of processing circuit 116), a control circuit 212 (corresponding to control circuit 112), a remote memory 222 (corresponding to remote memory 122), and a remote memory 224 (corresponding to remote memory 124).

FIG. 2 further illustrates a data fabric 230, a buffer 232, a buffer 234, and a switch 236. Data fabric 230 can correspond to a data fabric, for connecting memory devices (e.g., remote memory 222, remote memory 224, and/or local memory 220) to various processing circuits (e.g., processing circuit 214A, processing circuit 214B, processing circuit 216A, and/or processing circuit 216B). Buffer 232 can correspond to a buffer, queue, and/or other data structure or representation for tracking outstanding memory requests to remote memory 222 (e.g., memory requests in which remote memory 222 has not provided a corresponding response). Similarly, buffer 234 can correspond to a buffer, queue, and/or other data structure or representation for tracking outstanding memory requests to remote memory 224. Control circuit 212 can manage memory traffic for data fabric 230, which in some examples includes using buffer 232 and/or buffer 234 as will be described further. In some implementations, control circuit 212 can represent a centralized control circuit capable of separate decision points at each end point (e.g., for each processing circuit such as processing circuit 214A, processing circuit 214B, processing circuit 216A, and/or processing circuit 216B), although in other implementations, control circuit 212 can represent one or more control circuits in a distributed fashion (e.g., a separate control circuit for one or more processing circuit in any combination such as a separate control circuit for each processing circuit, a separate control circuit for each class/type of processing circuit, etc.) Switch 236 can correspond to a network switch or otherwise represent any network connectivity device. Moreover, the components illustrated in FIG. 2 can in other examples represent additional iterations and/or variations thereof. In addition, although FIG. 2 illustrates local memory 220, in some implementations, system 200 can have remote memory devices without any local memory.

In some examples, the various processing circuits can generate memory requests for the memory devices. Data fabric 230 can accordingly route memory requests to destination memory devices, which in some implementations can include identifying a physical address/device from a virtual address, as well as route corresponding responses to the original requestor. The memory devices (e.g., remote memory 222, remote memory 224, and/or local memory 220) can correspond to a tiered memory architecture, in which certain memory devices can have faster performance and smaller capacity (e.g., local memory 220 which can be a fast memory corresponding to a higher memory bandwidth and/or a lower latency from being locally attached), and certain other memory devices can have slower performance (e.g., corresponding to a higher latency and/or a lower memory bandwidth) and greater capacity (e.g., remote memory 222 and/or remote memory 224 which can have greater capacity than local memory 220 but higher latency from being remotely attached). Thus, local memory 220 can be associated with performance-sensitive memory traffic, and the remote memory devices (e.g., remote memory 222 and/or remote memory 224) can be associated with less performance-sensitive memory traffic. Further, the remote memory devices can also correspond to different performance/capacity tiers (e.g., remote memory 224 having more capacity and latency than remote memory 222). Accordingly, data fabric 230 can route both performance-sensitive memory traffic and less performance-sensitive memory traffic.

However, a load condition on one of the remote memory devices can create stalling in the memory traffic through data fabric 230. A load condition can correspond to any condition causing a higher latency than expected for normal operation. Examples of load conditions can include, without limitation, a physical issue (e.g., physical damage and/or overheating of circuits), a connectivity issue (e.g., damage and/or errors with links, buses, and/or other connections), overloading (e.g., receiving requests at a faster rate than can be responded to), overhead (e.g., reduced performance for example due to administrative tasks, changing operational modes, etc.), and/or combinations thereof. In some examples, the remote memory devices can be susceptible to load conditions due to physical distance (e.g., having a longer signal path as compared to local memory 220), increased potential due to sharing with additional processing circuits (e.g., remote memory 224 can be shared with other computing devices connected to switch 236), etc.

In some implementations, control circuit 212 can detect load conditions in the remote memory devices based on one or more factors or signals. In some implementations, the remote memory devices can report (directly or indirectly to control circuit 212) load conditions. For example, remote memory 222 can be connected through an interface that includes a protocol for reporting a status, such as various load conditions (e.g., light load, normal load, moderate overload, severe overload). In such examples, control circuit 212 can detect the load condition by receiving the status from remote memory 222. Remote memory 222 can periodically send the status and/or send the status in response to a change in the status.

In some examples, the remote memory devices can be limited in reporting statuses, for example by lacking status reporting (e.g., in a given protocol), lacking a reporting mechanism, lacking a reporting conduit to control circuit 212, etc. Control circuit 212 can, in addition and/or alternatively to a status reporting, detect load conditions by measuring performance of the remote memory devices and detecting a performance drop (e.g., below a performance threshold) as a load condition. For example, control circuit 212 can be limited in receiving statuses from remote memory 224 that is connected via switch 236. Buffer 234 can correspond to a queue of memory requests to remote memory 224. Control circuit 212 can add new memory requests for remote memory 224 to buffer 234 (e.g., by adding the request itself, an identifier for the request, and/or incrementing a counter). As remote memory 224 provides responses to the pending requests, control circuit 212 can remove the corresponding memory requests from buffer 234 (e.g., by finding and removing the corresponding memory request and/or decrementing the counter). Accordingly, by tracking buffer 234, control circuit 212 can detect and/or estimate load conditions on remote memory 224, which can be indicated by buffer 234 satisfying a buffer threshold (e.g., a count of buffer 234 reaching a threshold count or a threshold fullness such as 60%). In addition, control circuit 212 can similarly detect load conditions on remote memory 222 by tracking buffer 232, allowing control circuit 212 to detect load conditions in multiple ways.

Control circuit 212 can be configured to manage memory traffic handled by data fabric 230. However, in some implementations, control circuit 212 can be limited in directly addressing load conditions on the remote memory devices. For instance, control circuit 212 can be limited in observing/managing shared access to remote memory 224 with other computing devices (e.g., other remote computing device connected to remote memory 224 via switch 236). To mitigate performance degradation due to load conditions on the remote memory devices, control circuit 212 can prioritize certain memory requests, such as prioritizing performance-sensitive memory requests (e.g., to local memory 220) over less performance-sensitive memory requests (e.g., to remote memory 222 and/or remote memory 224).

In some implementations, control circuit 212 can prioritize performance-sensitive memory requests by reducing less performance-sensitive memory requests from congesting data fabric 230. For example, control circuit 212 can throttle the sources of the less performance-sensitive memory requests. Control circuit 212 can identify which of the processing circuits (e.g., processing circuit 214A, processing circuit 214B, processing circuit 216A, and processing circuit 216B) are remote-memory-biased. In some examples, a processing circuit can be remote-memory-biased if its memory traffic satisfies a remote-memory-bias threshold, corresponding to an amount of memory requests to remote memory devices. For example, the remote-memory-bias threshold can correspond to a percent of memory traffic (e.g., 50%, 90%, etc.) that is directed to remote memory devices rather than other memory devices. Moreover, a processing circuit can be more biased to remote memory devices than local memory devices if its memory traffic is directed to remote memory devices than to local memory devices (e.g., corresponding to a 50% remote-memory-bias threshold although other values can be used). In addition, in some implementations the thresholds described herein (e.g., one or more of the remote-memory-bias thresholds) can be configured during a system boot up or initialization process. In some implementations, the thresholds described herein can be runtime configurable and/or otherwise dynamically adjusted.

In some implementations, control circuit 212 can indirectly determine whether a processing circuit is remote-memory-biased. For example, memory requests can use virtual and/or physical addresses such that the destination memory device can be unknown. Accordingly, control circuit 212 can track responses to requests that identify which memory device sent the response. Control circuit 212 can track, for each of the processing circuits, which memory request responses originated from remote memory devices and which memory request responses originated from other (local) memory devices. In some examples, control circuit 212 can track the responses for each processing circuit for a time period (e.g., a number of cycles, an amount of time, a number of requests, etc.) which can further correspond to a rolling window of received responses. Control circuit 212 can identify a processing circuit as a remote-memory-biased processing circuit if the number of responses from remote memory devices over the time period satisfies the remote-memory-bias threshold. Moreover, in some implementations, other history-based mechanisms (e.g., based on tracking historical performance) can also predict the biasing of a current stream of physical addresses.

In one example, control circuit 212 can detect that processing circuit 216B received enough responses from remote memory 222 and/or remote memory 224 over a measured time period to satisfy the remote-memory-bias threshold and identify processing circuit 216B as remote-memory-biased. In other examples, control circuit 212 can have more granular tracking, such as tracking traffic for each remote memory device, incorporating different thresholds for different remote memory devices and/or different processing circuits, applying multiple levels of thresholds (e.g., low bias corresponding to a lower threshold such as 50%, high bias corresponding to a higher threshold such as 90%, etc.). Further, control circuit 212 can dynamically track and identify which processing circuits are remote-memory-biased and which are not, as will be explained further with respect to FIG. 3. In addition, in some implementations, control circuit 212 can selectively track or not track certain processing circuits. For instance, control circuit 212 can be configured (e.g., at boot up and/or at runtime) to certain not include processing circuits for tracking (e.g., for detecting load conditions and/or for determining remote memory bias) and/or certain processing circuits can otherwise be masked from being tracked by control circuit 212.

FIG. 3 illustrates a state diagram 300 corresponding to how a control circuit (e.g., control circuit 212) can apply different operational modes for a processing circuit (e.g., processing circuit 214A, processing circuit 214B, processing circuit 216A, and/or processing circuit 216B). A processing circuit can start as local memory biased 340, operating in a normal mode 342 (e.g., operating without any further conditions regarding memory traffic). The control circuit can continuously monitor the processing circuit for a remote bias condition 362, corresponding to the processing circuit having memory traffic satisfying the remote-memory-bias threshold as described above.

Upon detecting remote bias condition 362, the control circuit can identify the processing circuit as remote-memory-biased 350 such that the control circuit can instruct the processing circuit to operate in a remote-memory-biased mode 352. In some examples, remote-memory-biased mode 352 indicates that the processing circuit is biased to remote memory (and can be selected for throttling) although in other examples, remote-memory-biased mode 352 can include operational changes, such as increased tracking/monitoring by the control circuit, reduced prioritization of memory traffic, etc. Further, in some implementations, different levels/variations of remote bias condition 362 (e.g., corresponding to different thresholds) can lead to different levels/variations of remote-memory-biased mode 352. In remote-memory-biased mode 352, if the control circuit detects a normal bias condition 364 (which can correspond to the memory traffic no longer satisfying the remote-memory-bias threshold and/or a different threshold), the control circuit can instruct the processing circuit to return to normal mode 342.

In addition, in remote-memory-biased mode 352, if the control circuit detects a load condition 366, the control circuit can throttle the processing circuit at a throttled mode 354. The control circuit can throttle the processing circuit in one or more ways. For example, the control circuit can reduce a clock frequency, voltage, and/or other operating parameter of the processing circuit. In other examples, the control circuit can insert delays (e.g., a set or variable number of idle cycles) between some or all memory requests from the processing circuit. In yet other examples, the control circuit can emulate a reduced availability of transmit credits. For instance, the processing circuit can keep track of a number of transmit credits which get decremented upon sending a memory request and incremented upon receiving a response. By emulating a reduction of credits, the processing circuit can operate as if less transmit credits are available for sending memory requests.

Load condition 366 can correspond to any of the load conditions described herein, and further can correspond to a load condition in the data fabric itself (e.g., data fabric 230). In addition, different levels/variations of load condition 366 can lead to different levels/variations of throttled mode 354 (e.g., different levels of throttling).

From throttled mode 354, if the control circuit detects an end condition 368 (e.g., no longer detecting load condition 366 and/or actively detecting an end to load condition 366), the processing circuit can return to remote-memory-biased mode 352, which can effectively reduce and/or halt the throttling. For example, the control circuit can restore operating parameters (e.g., clock frequency, voltage, etc.), remove delays, restore transmit credits, etc. In some examples, the control circuit can gradually reduce throttling. Accordingly, the processing circuit can transition between the various modes as described.

FIG. 4 is a flow diagram of an exemplary computer-implemented method 400 for remote memory traffic management. The steps shown in FIG. 4 can be performed by any suitable computer-executable code and/or computing system, including the system(s) illustrated in FIGS. 1 and/or 2. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein identify a remote-memory-biased processing circuit of one or more processing circuits having memory traffic that is more biased to one or more remote memory devices than to one or more local memory devices. For example, control circuit 112 can identify processing circuit 116 as having memory traffic that is more biased to remote memory 122 and/or remote memory 124 than to memory 120.

The systems described herein can perform step 402 in a variety of ways. In one example, identifying the remote-memory-biased processing circuit identifying memory request responses received by the remote-memory-biased processing circuit that originate from the one or more remote memory devices, and tracking a number of the memory request responses received by the remote-memory-biased processing circuit that originate from the one or more remote memory devices for a time period. Control circuit 112 can identify the remote-memory-biased processing circuit is based on the number of the memory request responses satisfying a remote-memory-bias threshold, as described herein.

At step 404 one or more of the systems described herein detect a load condition on the one or more remote memory devices. For example, control circuit 112 can detect a load condition on remote memory 124.

The systems described herein can perform step 404 in a variety of ways. In one example, detecting the load condition can include receiving a status from the one or more remote memory devices. In some examples, control circuit 112 can detect the load condition by tracking one or more memory request buffers associated with the one or more remote memory devices and detecting at least one of the one or more memory request buffers satisfying a buffer threshold, as described herein.

At step 406 one or more of the systems described herein throttle, based on the load condition, the remote-memory-biased processing circuit. For example, control circuit 112 can throttle processing circuit 116.

The systems described herein can perform step 406 in a variety of ways. In one example, throttling the remote-memory-biased processing circuit can include at least one of inserting delays between memory requests or emulating a reduced availability of transmit credits, as described herein.

At step 408 one or more of the systems described herein detect an end of the load condition. For example, control circuit 112 can detect the load condition ending, as described herein.

At step 410 one or more of the systems described herein halt, in response to detecting the end of the load condition, the throttling of the remote-memory-biased processing circuit. For example, control circuit 112 can reduce, halt or otherwise stop throttling processing circuit 116 as described herein.

FIG. 5 is a flow diagram of an exemplary computer-implemented method 500 for remote memory traffic management. The steps shown in FIG. 5 can be performed by any suitable computer-executable code and/or computing system, including the system(s) illustrated in FIGS. 1 and/or 2. In one example, each of the steps shown in FIG. 5 represent an algorithm whose structure includes and/or is represented by multiple sub-steps, examples of which will be provided in greater detail below.

As illustrated in FIG. 5, at step 502 one or more of the systems described herein identify one or more remote-memory-biased processing circuits. For example, control circuit 212 can identify processing circuit 216B as being remote-memory-biased, as described herein.

At step 504 one or more of the systems described herein detect a load condition affecting a data fabric. For example, control circuit 212 can detect a load condition that affects data fabric 230, such as one or more of the load conditions affecting remote memory 222 and/or remote memory 224, and/or any other load condition with data fabric 230 (e.g., a load condition with local memory 220, memory traffic congestion in data fabric 230 such as due to overheating, etc.).

At step 506 one or more of the systems described herein select at least one of the one or more remote-memory-biased processing circuits. For example, control circuit 212 can select processing circuit 216B as well as other processing circuits that have been identified as remote-memory-biased (e.g., processing circuit 214A, processing circuit 214B, and/or processing circuit 216A).

At step 508 one or more of the systems described herein throttle memory requests from the selected at least one of the one or more remote-memory-biased processing circuits. For example, control circuit 212 can throttle the selected processing circuits using one or more of the throttling techniques described herein. In addition, control circuit 212 can apply different throttling techniques to different processing circuits and/or apply different levels of throttling.

At step 510 one or more of the systems described herein end the throttling when the load condition is no longer detected. For example, control circuit 212 can detect an end condition and reduce or halt the throttling, as described herein. In addition, control circuit 212 can apply different reductions of throttling to different processing circuits.

As detailed above, the systems and methods provided herein are directed to reducing the interference between Far (e.g., remote) and Near (e.g., local) memory traffics to improve SOC performance. SOC performance improvement can involve slowing down the memory traffic component that is less performance sensitive and allowing uninhibited progress of the memory traffic component directly impacting an overall performance.

Timely control, as described herein, prevents heavy load traffic targeting device/fabric attached memories from slowing down or otherwise impacting latency sensitive traffic (e.g., traffic targeting local DRAM).

In some examples, memory bandwidth tracking can be built as leaky bucket with incoming responses from a remote memory device incrementing the buffer, and decrementing the buffer at every (configurable) time-interval. The buffer value can be compared with configurable limits to trigger the transition between remote-memory-biased and normal modes. Throttling can be implemented by inserting (configurable) latency between requests or controlling the request submission rate to a configurable low limit. In some implementations, software-based notifications indicating the memory target of the IO activity can be combined with aforementioned tracking to assist SOC/Fabric in maximizing the system throughput.

In some implementations, the traffic submission rate can be tracked by sampling, over a firmware configurable time-interval, whether a response is from a remote memory device.

In some aspects, the techniques described herein relate to a device including: a control circuit configured to: identify a remote-memory-biased processing circuit of one or more processing circuits having memory traffic that is biased to one or more remote memory devices; and throttle, based on a load condition, the remote-memory-biased processing circuit.

In some aspects, the techniques described herein relate to a device, wherein identifying the remote-memory-biased processing circuit includes identifying memory request responses received by the remote-memory-biased processing circuit that originate from the one or more remote memory devices.

In some aspects, the techniques described herein relate to a device, wherein identifying the remote-memory-biased processing circuit further includes tracking a number of the memory request responses received by the remote-memory-biased processing circuit that originate from the one or more remote memory devices for a time period.

In some aspects, the techniques described herein relate to a device, wherein identifying the remote-memory-biased processing circuit is based on the number of the memory request responses satisfying a remote-memory-bias threshold.

In some aspects, the techniques described herein relate to a device, wherein detecting the load condition includes receiving a status from the one or more remote memory devices.

In some aspects, the techniques described herein relate to a device, wherein detecting the load condition includes: tracking one or more memory request buffers associated with the one or more remote memory devices; and detecting at least one of the one or more memory request buffers satisfying a buffer threshold.

In some aspects, the techniques described herein relate to a device, wherein throttling the remote-memory-biased processing circuit includes at least one of inserting delays between memory requests or emulating a reduced availability of transmit credits.

In some aspects, the techniques described herein relate to a device, wherein the control circuit is further configured to: detect an end of the load condition; and halt, in response to detecting the end of the load condition, the throttling of the remote-memory-biased processing circuit.

In some aspects, the techniques described herein relate to a system including: one or more local memory devices; one or more processing circuits; a data fabric configured to couple the one or more processing circuits with the one or more local memory devices and one or more remote memory devices; and a control circuit configured to: identify a remote-memory-biased processing circuit of the one or more processing circuits having memory traffic that is more biased to the one or more remote memory devices than to the one or more local memory devices; and throttle, based on a load condition on the one or more remote memory devices, the remote-memory-biased processing circuit.

In some aspects, the techniques described herein relate to a system, wherein identifying the remote-memory-biased processing circuit includes identifying memory request responses received by the remote-memory-biased processing circuit that originate from the one or more remote memory devices.

In some aspects, the techniques described herein relate to a system, wherein identifying the remote-memory-biased processing circuit further includes tracking a number of the memory request responses received by the remote-memory-biased processing circuit that originate from the one or more remote memory devices for a time period, and identifying the remote-memory-biased processing circuit is based on the number of the memory request responses satisfying a remote-memory-bias threshold.

In some aspects, the techniques described herein relate to a system, wherein detecting the load condition includes receiving a status from the one or more remote memory devices.

In some aspects, the techniques described herein relate to a system, wherein detecting the load condition includes: tracking one or more memory request buffers of the data fabric associated with the one or more remote memory devices; and detecting at least one of the one or more memory request buffers satisfying a buffer threshold.

In some aspects, the techniques described herein relate to a system, wherein throttling the remote-memory-biased processing circuit includes at least one of inserting delays between memory requests or emulating a reduced availability of transmit credits.

In some aspects, the techniques described herein relate to a system, wherein the control circuit is further configured to: detect an end of the load condition; and halt, in response to detecting the end of the load condition, the throttling of the remote-memory-biased processing circuit.

In some aspects, the techniques described herein relate to a method including: identifying a remote-memory-biased processing circuit of one or more processing circuits having memory traffic that is more biased to one or more remote memory devices than to one or more local memory devices; throttling, based on a load condition on the one or more remote memory devices, the remote-memory-biased processing circuit; detecting an end of the load condition; and halting, in response to detecting the end of the load condition, the throttling of the remote-memory-biased processing circuit.

In some aspects, the techniques described herein relate to a method, wherein identifying the remote-memory-biased processing circuit includes: identifying memory request responses received by the remote-memory-biased processing circuit that originate from the one or more remote memory devices; and tracking a number of the memory request responses received by the remote-memory-biased processing circuit that originate from the one or more remote memory devices for a time period; and wherein identifying the remote-memory-biased processing circuit is based on the number of the memory request responses satisfying a remote-memory-bias threshold.

In some aspects, the techniques described herein relate to a method, wherein detecting the load condition includes receiving a status from the one or more remote memory devices.

In some aspects, the techniques described herein relate to a method, wherein detecting the load condition includes: tracking one or more memory request buffers associated with the one or more remote memory devices; and detecting at least one of the one or more memory request buffers satisfying a buffer threshold.

In some aspects, the techniques described herein relate to a method, wherein throttling the remote-memory-biased processing circuit includes at least one of inserting delays between memory requests or emulating a reduced availability of transmit credits.

As detailed above, the computing devices and systems described and/or illustrated herein broadly represent any type or form of computing device or system capable of executing computer-readable instructions, such as those contained within the code/firmware/programs described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the instructions and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more instructions stored in the above-described memory device. Examples of physical processors include, without limitation, chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor.

In some examples, the term “physical processor” also refers to and/or includes a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in the above-described memory device. Examples of co-processors include, without limitation, chiplets, microprocessors, microcontrollers, graphics processing units (GPUs), FPGAs that implement softcore processors, ASICs, SoCs, DSPs, NNEs, accelerators, portions of one or more of the same, variations or combinations of one or more of the same, and/or any other suitable physical processor.

Although described as separate elements/steps, the instructions described and/or illustrated herein can represent portions of a single program or application, including instructions implemented in code, firmware, one or more circuits, etc. In addition, in certain implementations one or more of these instructions can represent one or more software applications or programs that, when executed by a computing device, cause the computing device to perform one or more tasks. For example, one or more of the instructions described and/or illustrated herein represent instructions stored and configured to run on one or more of the computing devices or systems described and/or illustrated herein. In some implementations, one or more instructions can be implemented as a circuit or circuitry, including as part of a firmware, a ROM, one or more logic units, etc. One or more of these instructions can also represent or otherwise be implemented with all or portions of one or more special-purpose computers configured to perform one or more tasks.

In addition, one or more of the instructions and/or corresponding circuits described herein transforms data, physical devices, and/or representations of physical devices from one form to another. Additionally, or alternatively, one or more of the instructions recited herein can transform a processor, volatile memory, non-volatile memory, and/or any other portion of a physical computing device from one form to another by executing on the computing device, storing data on the computing device, and/or otherwise interacting with the computing device.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a control circuit configured to:
identify a remote-memory-biased processing circuit of one or more processing circuits having memory traffic that is biased to one or more remote memory devices; and
throttle, based on a load condition, the remote-memory-biased processing circuit.

2. The device of claim 1, wherein identifying the remote-memory-biased processing circuit comprises identifying memory request responses received by the remote-memory-biased processing circuit that originate from the one or more remote memory devices.

3. The device of claim 2, wherein identifying the remote-memory-biased processing circuit further comprises tracking a number of the memory request responses received by the remote-memory-biased processing circuit that originate from the one or more remote memory devices for a time period.

4. The device of claim 3, wherein identifying the remote-memory-biased processing circuit is based on the number of the memory request responses satisfying a remote-memory-bias threshold.

5. The device of claim 1, wherein detecting the load condition comprises receiving a status from the one or more remote memory devices.

6. The device of claim 1, wherein detecting the load condition comprises:
tracking one or more memory request buffers associated with the one or more remote memory devices; and
detecting at least one of the one or more memory request buffers satisfying a buffer threshold.

7. The device of claim 1, wherein throttling the remote-memory-biased processing circuit comprises at least one of inserting delays between memory requests or emulating a reduced availability of transmit credits.

8. The device of claim 1, wherein the control circuit is further configured to:
detect an end of the load condition; and
halt, in response to detecting the end of the load condition, the throttling of the remote-memory-biased processing circuit.

9. A system comprising:
one or more local memory devices;
one or more processing circuits;
a data fabric configured to couple the one or more processing circuits with the one or more local memory devices and one or more remote memory devices; and
a control circuit configured to:
identify a remote-memory-biased processing circuit of the one or more processing circuits having memory traffic that is more biased to the one or more remote memory devices than to the one or more local memory devices; and
throttle, based on a load condition on the one or more remote memory devices, the remote-memory-biased processing circuit.

10. The system of claim 9, wherein identifying the remote-memory-biased processing circuit comprises identifying memory request responses received by the remote-memory-biased processing circuit that originate from the one or more remote memory devices.

11. The system of claim 10, wherein identifying the remote-memory-biased processing circuit further comprises tracking a number of the memory request responses received by the remote-memory-biased processing circuit that originate from the one or more remote memory devices for a time period, and identifying the remote-memory-biased processing circuit is based on the number of the memory request responses satisfying a remote-memory-bias threshold.

12. The system of claim 9, wherein detecting the load condition comprises receiving a status from the one or more remote memory devices.

13. The system of claim 9, wherein detecting the load condition comprises:
tracking one or more memory request buffers of the data fabric associated with the one or more remote memory devices; and
detecting at least one of the one or more memory request buffers satisfying a buffer threshold.

14. The system of claim 9, wherein throttling the remote-memory-biased processing circuit comprises at least one of inserting delays between memory requests or emulating a reduced availability of transmit credits.

15. The system of claim 9, wherein the control circuit is further configured to:
detect an end of the load condition; and
halt, in response to detecting the end of the load condition, the throttling of the remote-memory-biased processing circuit.

16. A method comprising:
identifying a remote-memory-biased processing circuit of one or more processing circuits having memory traffic that is more biased to one or more remote memory devices than to one or more local memory devices;
throttling, based on a load condition on the one or more remote memory devices, the remote-memory-biased processing circuit;
detecting an end of the load condition; and
halting, in response to detecting the end of the load condition, the throttling of the remote-memory-biased processing circuit.

17. The method of claim 16, wherein identifying the remote-memory-biased processing circuit comprises:
identifying memory request responses received by the remote-memory-biased processing circuit that originate from the one or more remote memory devices; and
tracking a number of the memory request responses received by the remote-memory-biased processing circuit that originate from the one or more remote memory devices for a time period;
wherein identifying the remote-memory-biased processing circuit is based on the number of the memory request responses satisfying a remote-memory-bias threshold.

18. The method of claim 16, wherein detecting the load condition comprises receiving a status from the one or more remote memory devices.

19. The method of claim 16, wherein detecting the load condition comprises:
tracking one or more memory request buffers associated with the one or more remote memory devices; and
detecting at least one of the one or more memory request buffers satisfying a buffer threshold.

20. The method of claim 16, wherein throttling the remote-memory-biased processing circuit comprises at least one of inserting delays between memory requests or emulating a reduced availability of transmit credits.
